(19) United States
(12) Patent Application Publication
(10) Pub. No.: US 2011/0315934 A1
(43) Pub. Date: Dec. 29, 2011

(54) Method for fabrication of functionalized graphene reinforced composite conducting plate

(75) Inventors: Chen-Chi M. Ma, Hsinchu (TW); Min-Chien Hsiao, Hsinchu (TW); Shu-Hang Liao, Hsinchu (TW); Ming-Yu Yen, Hsinchu (TW); Ming-Der Ger, Taoyuan (TW); Chung-An Wang, Taoyuan (TW); Nen-Wen Pu, Taoyuan (TW); Yuh Sung, Taoyuan (TW); Chih-Chun Teng, Hsinchu (TW); Shie-Heng Lee, Hsinchu (TW); Min-Hsuan Hsiao, Hsinchu (TW)

(73) Assignee: National Tsing Hua University, Hsinchu (TW)

(21) Appl. No.: 12/923,545

(22) Filed: Sep. 28, 2010

(30) Foreign Application Priority Data
Jun. 24, 2010 (TW) 99120703

(51) Int. Cl. H01B 1/24

(52) U.S. Cl. 252/511

(57) ABSTRACT

A graphite-vinyl ester resin composite conducting plate is prepared in the present invention. The conducting plate can be used as a bipolar plate for a fuel cell, counter electrode for dye-sensitized solar cell and electrode of vanadium redox battery. The conducting plate is prepared as follows: a) compounding vinyl ester resin and graphite powder to form a bulk molding compound (BMC) material, the graphite powder content ranging from 70 wt % to 95 wt % based on the total weight of the graphite powder and vinyl ester, wherein 0.01-15 wt % functionalized graphene, based on the weight of the vinyl ester resin, are added during the compounding; b) molding the BMC material from step a) to form a conducting plate having a desired shaped at 80-250° C. and 500-4000 psi.

### FIELD OF THE INVENTION

The present invention relates to a method for preparing a graphite-vinyl ester resin composite conducting plate, and in particular to a method for preparing a functionalized graphene reinforced graphite-vinyl ester resin composite conducting plate. The conducting plate can be used as a bipolar plate for a fuel cell, counter electrode for dye-sensitized solar cell and electrode of vanadium redox battery.

### BACKGROUND OF THE INVENTION

U.S. Pat. No. 7,090,793 discloses a composite bipolar plate of polymer electrolyte membrane fuel cells (PEMFC), which is prepared as follows: a) preparing a bulk molding compound (BMC) material containing a vinyl ester resin and a graphite powder, the graphite powder content of BMC material ranging from 60 wt % to 80 wt %, based on the compounded mixture; b) molding the BMC material from step a) to form a bipolar plate having a desired shape at 80-200° C. and 500-4000 psi, wherein the graphite powder is of 10 mesh-80 mesh. Details of the disclosure in this US patent are incorporated herein by reference.

Taiwan patent publication No. 200624604, published 16 Jul. 2006, discloses a PEMFC, which is prepared as follows: a) compounding phenolic resin and carbon fillers to form bulk molding compound (BMC) material, the BMC material containing 60 to 80 wt % graphite powder, 1 to 10 wt % carbon fiber; and one or more conductive carbon fillers selected from: 5 to 30 wt % Ni-planted graphite powder, 2 to 8 wt % Ni-planted carbon fiber and 0.01 to 0.3 wt % carbon nano tubes, based on the weight of the phenolic resin, provided that the sum of the amounts of the carbon fiber and Ni-planted carbon fiber is not greater than 10 wt %; b) molding the BMC material from step a) to form a bipolar plates having a desired shape at 80-200° C. and 500-4000 psi. The carbon nanotubes used in this prior art are single-walled or double-walled carbon nanotubes having a diameter of 0.7-50 nm, length of 1-1000 μm, specific surface area of 40-1000 m²/g. Details of the disclosure in this Taiwan patent publication are incorporated herein by reference.

USP 2006/0267235 A1 discloses a composite bipolar plate for a PEMFC, which is prepared as follows: a) compounding vinyl ester and graphite powder to form bulk molding compound (BMC) material, the graphite powder content ranging from 60 wt % to 95 wt % based on the total weight of the graphite powder and vinyl ester, wherein carbon fiber 1-20 wt %, modified organo clay or noble metal plated modified organo clay 0.5-10 wt %, and one or more conductive fillers selected form: carbon nanotube (CNT) 0.1-5 wt %, nickel plated carbon fiber 0.5-10 wt %, nickel plated graphite 2.5-40 wt %, and carbon black 2-30 wt %, based on the weight of the vinyl ester resin, are added during the compounding; b) molding the BMC material from step a) to form a bipolar plate having a desired shaped at 80-200° C. and 500-4000 psi. Details of the disclosure in this US patent publication are incorporated herein by reference.

USP 2007/0241475 A1 discloses a composite bipolar plate for a PEMFC, which is prepared as follows a) compounding vinyl ester and graphite powder to form bulk molding compound (BMC) material, the graphite powder content ranging from 60 wt % to 95 wt % based on the total weight of the graphite powder and vinyl ester, wherein 0.5-10 wt % modified organo clay by intercalating with a polyether amine, based on the weight of the vinyl ester resin, is added during the compounding; b) molding the BMC material from step a) to form a bipolar plates having a desired shaped at 80-200° C. and 500-4000 psi. Details of the disclosure in this US patent publication are incorporated herein by reference.

US patent publication No. 2008/0242785 A1, commonly assigned to the assignee of the present application discloses TiO₂-coated CNTs formed by a sol-gel method or hydrothermal method. Furthermore, the TiO₂-coated CNTs are modified with a coupling agent to endow the TiO₂-coated CNTs with affinity to polymer substrates. The modified TiO₂-coated CNTs can be used as an additive in polymers or ceramic materials for increase the mechanical strength of the resulting composite materials. The CNT/polymer composite material prepared according to this prior art can be used to impregnate fiber cloth to form a prepreg material. Details of the disclosure in this US patent application are incorporated herein by reference.

To this date, the industry is still continuously looking for a smaller fuel cell bipolar plate having a high electric conductivity, excellent mechanical properties, a high thermal stability and a high size stability.

Graphene was reported as a single layer of carbon atoms compactly packed into a two-dimensional honeycomb lattice. Graphene is a potential new material for developing novel nanomaterial in a variety of applications, due to its unusual electronic character (with carrier mobilities up to 200,000 cm² V⁻¹ s⁻¹), high thermal conductivity (˜4840-5300 W m⁻¹ K⁻¹), high mechanical properties and elasticity.

### SUMMARY OF THE INVENTION

One primary objective of the present invention is to provide a process for preparing a graphite-vinyl ester resin composite conducting plate, and in particular to a process for preparing a graphite-vinyl ester resin composite conducting plate reinforced by a functionalized graphene. The conducting plate prepared according to the process of the present invention have a high electric conductivity, high thermal conductivity and excellent mechanical propertie.

Another objective of the present invention is to provide a process for preparing a bipolar plate for fuel cell.

Still another objective of the present invention is to provide a process for preparing a counter electrode for dye-sensitized solar cell.

A further objective of the present invention is to provide a process for preparing an electrode of vanadium redox battery.

In order to accomplish the aforesaid objectives a process for preparing a graphite-vinyl ester resin composite conducting plate reinforced by a functionalized graphene according to the present invention comprises the following steps:

a) compounding vinyl ester resin and graphite powder to form bulk molding compound (BMC) material, the graphite powder content ranging from 70 wt % to 95 wt % based on the total weight of the graphite powder and vinyl ester resin, wherein 0.01-15 wt % a functionalized graphene, based on the weight of the vinyl ester resin, is added during the compounding;

b) molding the BMC material from step a) to form a conducting plate having a desired shaped at 80-250° C. and 500-4000 psi.

Preferably, said functionalized graphene is a single-layered or a multiple-layered graphene, and has a length and a width of 100 nm-500 μm; and a thickness of 0.34 nm-10 nm. More preferably, said functionalized graphene is a 1-layered to 9-layered graphene, and has a length and a width of 1.0 μm-10.0 μm; and a thickness of 1.0 nm-5.0 nm.

Preferably, said functionalized graphene has a specific surface area of 100-2630 m²/g.

Preferably, said functionalized graphene has an oxygen-containing functional group of COOH, C—OH, C═O or C—O—C, the content of which is less than a weigh loss of 10 wt % measured by thermogravimetric analysis (TGA) heating from 100° C. to 800° C. at a heating rate of 2° C./min.

Preferably, said functionalized graphene is added with an amount of 0.1-2.0 wt % based on the weight of the vinyl ester resin.

Preferably, said functionalized graphene is prepared by reducing a graphite oxide having an oxygen-containing functional group of COOH, C—OH, C═O or C—O—C, the content of which is greater than a weight loss of 20 wt %, more preferably 30 wt %, measured by thermogravimetric analysis (TGA) heating from 100° C. to 800° C. at a heating rate of 2° C./min. Said reduction can be a chemical reduction, thermal reduction, hydrothermal reduction or a combination thereof. More preferably, said reduction is the thermal reduction carried out at a temperature of 150-1200° C. with a heating rate of 10-2000° C./min in an inert atmosphere for a period of 5-300 seconds.

Preferably, said graphite oxide is formed by oxidizing graphite powder with a strong acid and a strong oxidizing agent for a period of two hours to 10 days. Preferably, the graphite powder is natural graphite powder, expanded graphite, graphite carbon, soft graphite, or a mixture thereof. Preferably, the strong acid is an inorganic acid. Preferably, the oxidizing agent is KClO₃, KClO₄, KMnO₄, NaMnO₄, K₂S₂O₈, P₂O₅, NaNO₃ or a mixture thereof.

Preferably, said reduction is a chemical reduction by using a reducing agent, which can be hydrazine (N₂H₂), hydroquinone, sodium borohydride (NaBH₄), sodium citrate, hydroxide, ascorbic acid or a mixture thereof.

Preferably, said reduction is hydrothermal reduction by using water, alcohol, organic solvent or a mixture thereof.

Preferably, the conducting plate prepared in accordance with the process of the present invention has an electric conductivity not less than 250 S cm⁻¹.

Preferably, the conducting plate prepared in accordance with the process of the present invention has a flexural strength not less than 40 MPa.

Preferably, the conducting plate prepared in accordance with the process of the present invention has a thermal conductivity not less than 20 W/m K.

The present invention also provides a process for preparing a bipolar plate for fuel cell, which comprises aforesaid steps a) and b).

The present invention also provides a process for preparing a counter electrode for dye-sensitized solar cell, which comprises aforesaid steps a) and b).

The present invention also provides a process for preparing an electrode of vanadium redox battery, which comprises aforesaid steps a) and b).

In one of the preferred embodiments of the present invention a highly oxidized graphite oxide was subjected to a thermal reduction, and was then exfoliated to obtain a functionalized graphene having a length and width of 1 μm-6 μm, thickness of about 1.4 nm, a 4-layered to 5-layered graphite structure, and less than 10 wt % of oxygen-containing functional groups (weight loss percentage measured by TGA). 0.2 wt % of said functionalized graphene was dispersed as a reinforcement material in a graphite-vinyl ester composite, based on the weight of the vinyl ester resin, which was then molded by BMC molding to form a functionalized graphene reinforced conducting plate having a high electric conductivity, high thermal conductivity, and superior mechanical properties, such as an electric conductivity not less than 200 S cm⁻¹, thermal conductivity not less than 27 W m⁻¹ K⁻¹ and a flexural strength not less than 49 MPa, which are beyond the technical criteria indexes for the composite bipolar plate according to the DOE of US.

Preferably, particles of said graphite powder used in the compounding in step a) have a size of 10-80 mesh. More preferably, less than 10 wt % of the particles of the graphite powder are larger than 40 mesh, and the remaining particles of the graphite powder have a size of 40-80 mesh.

Preferably, a free radical initiator in an amount of 1-10% based on the weight of said vinyl ester resin is added during said compounding in step a). More preferably, said free radical initiator is selected from the group consisting of peroxide, hydroperoxide, azonitrile, redox system, persulfate, and perbenzoate. Most preferably, said free radical initiator is t-butyl peroxybenzoate.

Preferably, a mold releasing agent in an amount of 1-10%, based on the weight of said vinyl ester resin is added during said compounding in step a). More preferably, said mold releasing agent is wax or metal stearate. Most preferably, said mold releasing agent is metal stearate.

Preferably, a low shrinking agent in an amount of 5-20%, based on the weight of said vinyl ester resin is added during said compounding in step a). More preferably, said low shrinking agent is selected from the group consisting of styrene-monomer-diluted polystyrene resin, copolymer of styrene and acrylic acid, poly(vinyl acetate), copolymer of vinyl acetate and acrylic acid, copolymer of vinyl acetate and itaconic acid, and terpolymer of vinyl acetate, acrylic acid and itaconic acid. Most preferably, said low shrinking agent is styrene-monomer-diluted polystyrene resin.

Preferably, a tackifier in an amount of 1-10%, based on the weight of said vinyl ester resin is added during said compounding in step a). More preferably, said tackifier is selected from the group consisting of alkaline earth metal oxides, alkaline earth metal hydroxides, carbodiamides, aziridines, and polyisocyanates. Most preferably, said tackifier is calcium oxide or magnesium oxide.

Preferably, a solvent in an amount of 10-35%, based on the weight of said vinyl ester resin is added during said compounding in step a). More preferably, said solvent is selected from the group consisting of styrene monomer, alpha-methyl styrene monomer, chloro-styrene monomer, vinyl toluene monomer, divinyl toluene monomer, diallylphthalate monomer, and methyl methacrylate monomer. Most preferably, said solvent is styrene monomer.

The vinyl ester resins suitable for use in the present invention have been described in U.S. Pat. No. 6,248,467 which are methacrylated epoxy polyesters, preferably having a glass transition temperature (Tg) of over 180° C. Suitable examples of said vinyl ester resins include, but not limited to, bisphenol-A epoxy-based methacrylate, bisphenol-A epoxy-based acrylate, tetrabromo bisphenol-A epoxy-based methacrylate, and phenol-novolac epoxy-based methacrylate, wherein phenol-novolac epoxy-based methacrylate is preferred. Said vinyl ester resins have a molecular weight of about 500-10000, and an acid value of about 4 mg/1 h KOH-40 mg/1 h KOH.

### BRIEF DESCRIPTION OF THE DRAWINGS

FIGS. 1(a) and 1(b) are photographs taken by transmission electron microscopy (TEM) showing TEM observations of functionalized graphene prepared in the present invention with (a) low-magnification and (b) with high-magnification, respectively; and FIG. 1(c) is the selected area diffraction (SAED) pattern (the scale bar is 2 nm⁻¹).

FIG. 2 is X-ray photoelectron spectroscopy (XPS) spectra of graphite oxide and functionalized graphene prepared in the present invention.

FIG. 3 is a plot of weight retention (%) versus heating temperature during thermogravimetric analysis (TGA) of graphite oxide and functionalized graphene prepared in Preparation Example 1 of the present invention.

### DETAILED DESCRIPTION OF THE INVENTION

Micromechanical cleavage, liquid-phase exfoliation of graphite, and epitaxial growth have been considered as methods for preparing high-quality, non-oxidized monolayer graphene; however, the graphene sheets prepared by these methods are not preferable in comparison with the functionalized graphene prepared by thermally reducing graphite oxide. Although it is not contemplated to be bounded by the following theory, the inventors of the present invention think the functionalized graphene prepared in the present invention retains some residual oxygen-containing function groups, creating a better dispersion thereof in the vinyl ester resin system, and thus provides a surprising reinforcement effect to the graphite powder-vinyl ester resin composite.

The present invention discloses a process for preparing a composite conducting plate by a bulk molding compound (BMC) process with a bulk molding compound (BMC) material comprising vinyl ester, a conductive carbon (graphite powder), and functionalized graphene. The functionalized graphene reinforced vinyl ester/graphite composite conducting plate prepared with 0.2 wt % of functionalized graphene according to the present invention have an electrical conductivity, thermal stability, thermal conductivity and mechanical strength superior than those of the conducting plate prepared with carbon nanotubes which is 1 to 5 times of the amount of the functionalized graphene used.

The vinyl ester resin, initiators, and carbon nanotubes among other materials used in the following examples and controls are described as follows:
Vinyl ester resin: Bisphenol-A epoxy-based (methacrylate) vinyl ester resin having the following structure, which is available as code SW976 from SWANCOR IND. CO., LTD, No. 9, Industry South 6 Rd, Nan Kang Industrial Park, Nan-Tou City, Taiwan:

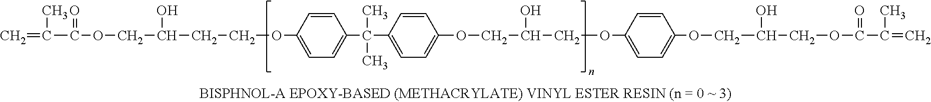

Initiator: t-Butyl peroxybenzoate (TBPB) having the following structure, which is available as code TBPB-98 from Taiwan Chiang-Ya Co, Ltd., 4 of 8^{th} Fl, No. 345, Chunghe Rd, Yuanhe City, Taipei Hsien:

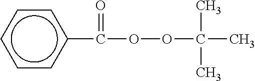

Multi-Walled CNT (abbreviated as MWCNT) produced by The CNT Company, Inchon, Korea, and sold under a code of C_{tube}100. This type of CNT was prepared by a CVD process. The CNTs had a diameter of 10-50 nm, a length of 1-25 μm, a specific surface area of 150-250 m² g⁻¹ and an aspect ratio of 20-2500.

The present invention will be better understood through the following examples, which are merely illustrative, not for limiting the scope of the present invention.

### Preparation Example 1

### Preparation of Functionalized Graphene

To 5 g of natural graphite powder (Alfa Aesar, particle size of about 70 μm, purity of 99.99995% and density of 2.25 g/cm³) in 500 three-neck flask sulfuric acid (87.5 mL) and nitric acid (45 mL) were added, and the mixture was stirred. When graphite was dispersed uniformly, potassium chlorate (55 g) was added slowly and stirred at a temperature of 0-4° C. for over 96 hours. After the completion of the oxidizing reaction, the mixture was added into deionized water bath and then filtered. The solid was rinsed and redispersed in a 5% solution of HCl repeatedly three times. It was then washed continuously with deionized water until the pH of the filtrate was neutral. The slurry was dried in vacuo and pulverized twice to obtain graphite oxide (GO).

Finally, the GO was placed in a furnace and argon was introduced into the furnace, which was then heated to 1050° C. for 30 seconds to form graphene.

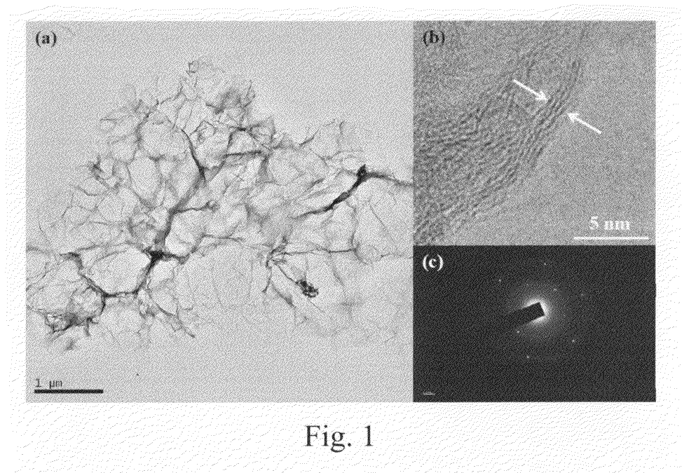

FIGS. 1(a) and 1(b) are photographs taken by transmission electron microscopy (TEM) showing TEM observations of functionalized graphene prepared above with (a) low-magnification and (b) with high-magnification, respectively; and FIG. 1(c) is the selected area diffraction (SAED) pattern (the scale bar is 2 nm⁻¹). It can be calculated from FIG. 1(a) that the area of the functionalized grapheme is about 6.5 μm×4 μm; and it can be seen from FIG. 1(b) that the functionalized graphene has a 4-layered or 5-layered structure with a total thickness of about 1.4 nm. FIG. 1(c) shows that the functionalized graphene has a high degree of crystallinity.

### Identification by X-Ray Photoelectron Spectroscopy (XPS)

X-ray irradiation on a solid surface can cause ionization of photoelectrons, the kinetic energy of which thus can be measured. Each atom has its unique binding energy, and accordingly the atom emitting the photoelectron can be identified as well as the chemical state thereof. This technique is named X-ray photoelectron spectroscopy (XPS) in view of the X-ray excitation of electron.

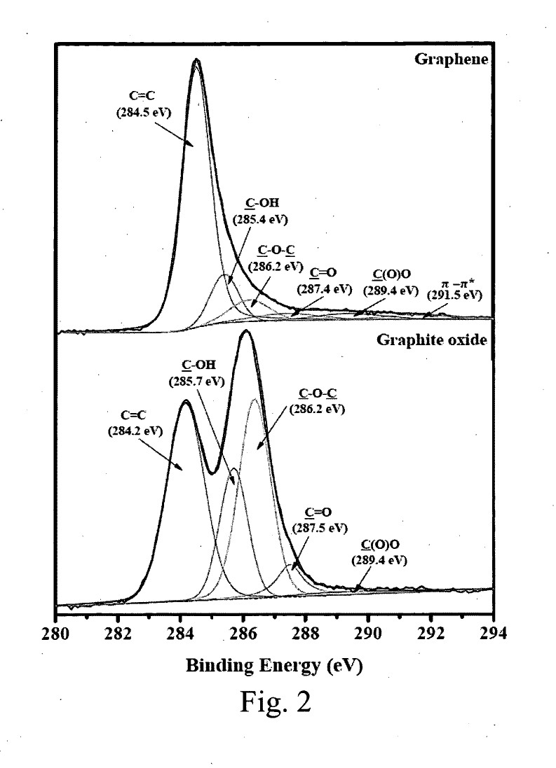

Qualitative characterization was conducted by X-ray photoelectron spectra (XPS) to elucidate the surface composition and variation of GO and graphene. FIG. 2 presents the C1s core level spectra of graphite oxide and graphene. The sp² C═C peak at 284.2 eV and deconvolution reveal three main oxygen component peaks presented in GO, C—OH (at 285.7 eV), C—O—C (at 286.2 eV), and C═O (at 50 287.5 eV), respectively, and a minor component from the O—C═O group appeared at 289.4 eV. The intensity summation consisting of C—OH and C—O—C obviously overtakes the sp² C═C peak, clearly reflecting a considerable degree of oxidation. The π-π* satellite peak at 291.5 eV assigned to π-electrons delocalized at the aromatic network in graphite, disappears with increasing oxidation. The peak intensities following subsequent thermal treatments associated with C—OH (285.4 eV), C—O—C (286.2 eV), and C═O (287.4 eV) decrease dramatically, indicating the removal of most of these functional groups from the graphene. The π-π* satellite peak at 291.5 eV observed in the graphene is too weak for characterizing in GO, indicating that the delocalized π conjugation is restored in the graphene. The sp² C═C peak at a slightly higher binding energy (0.3 eV up-shift) in graphene (284.5 eV) than in GO (284.2 eV), is located at the same binding energy as that in the raw graphite (284.5 eV, the C1s of XPS is not shown). This implies that the lack of π conjugation in the basal plane of GO leads to a higher energy state of sp² C═C, lowering the binding energy. In contrast, the recovery of the basal plane structure in graphene stabilizes the sp² C═C bonding, leading to a higher binding energy.

### Thermogravimetric Analysis (TGA) of Functionalized Graphene

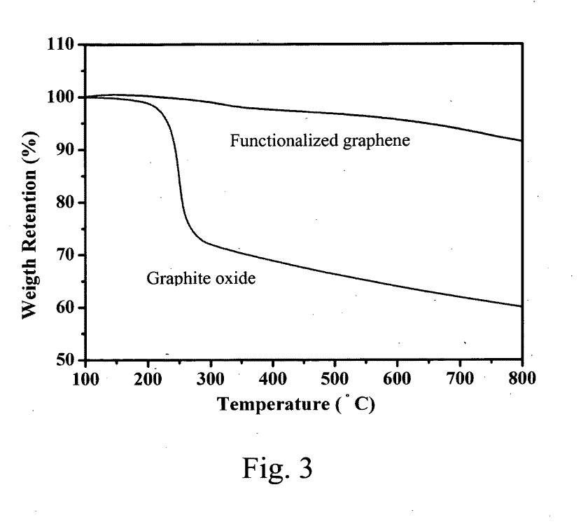

The thermal behavior of GO and graphene were investigated by thermogravmetric analysis (TGA) with a slow heating rate (2° C. min⁻¹) to avoid GO exfoliation during the scan. FIG. 3 plots the TGA curves of GO and graphene. The main weight loss of GO is found at 200° C.-300° C. because of the decomposition of oxygen-containing functional groups to CO, CO₂, and H₂O. The weight loss between 300 and 800° C. is 12 wt %, associated with the removal of more thermal stable oxygen functionalities, and thermal decomposition of GO. In contrast, graphene exhibits a much higher thermal stability compared to GO. The weight loss of 3 wt % below 500° C. illustrates residual oxygen-containing functional groups or absorbed water on graphene. Weight loss onset occurs at 550-600° C. relative to graphene thermal decomposition and is calculated as a total of 8 wt % weight loss at 800° C.

### Control Example 1

The graphite powder used in Control Example 1 consisted of not more than 10% of particles larger than 40 mesh (420 μm in diameter), about 40% of particles between 40 mesh and 60 mesh (420−250 μm in diameter), and about 50% of particles between 60 mesh and 80 mesh (250−177 μm in diameter).

### Preparation of BMC Material and Specimen

1. 192 g of a solution was prepared by dissolving 144 g of vinyl ester resin resin and 16 g of styrene-monomer-diluted polystyrene (as a low shrinking agent) in 32 g of styrene monomer as a solvent. 3.456 g of TBPB was added as an initiator, 3.456 g of MgO was added as a tackifier, and 6.72 g of zinc stearate was added as a mold releasing agent.
2. The solution resulting from step 1, and 448 g of graphite powder were poured into a Bulk Molding Compound (BMC) kneader to be mixed homogeneously by forward-and-backward rotations for a kneading time of about 30 minutes. The kneading operation was stopped and the mixed material was removed from the mixer to be thickening at room temperature for 36 hours.
3. Prior to thermal compression of specimens, the material was divided into several lumps of molding material with each lump weighing 65 g.
4. A slab mold was fastened to the upper and lower platforms of a hot press. The pre-heating temperature of the mold was set to 150° C. After the temperature had reached the set point, the lump was disposed at the center of the mold and pressed with a pressure of 3000 psi to form a specimen. After 300 seconds, the mold was opened automatically, and the specimen was removed.

### Control Examples 2-4

The steps in Control Example 1 were repeated to prepare lumps of molding material and specimens, except that various amounts of MWCNTs listed in Table 1 were added together with the graphite powder to the BMC kneader in step 2.

### Example 1

The steps in Control Example 1 were repeated to prepare lumps of molding material and specimens, except that 0.384 g of the functionalized graphene prepared in Preparation Example 1 was added together with the graphite powder to the BMC kneader in step 2.

TABLE 1

| Example | Reinforcement material | Amount added, g (wt %)* | |
|---|---|---|---|
| Control Ex. 1 | None | 0 | (0%) |
| Control Ex. 2 | MWCNTs | 0.384 | (0.2%) |
| Control Ex. 3 | MWCNTs | 0.960 | (0.5%) |
| Control Ex. 4 | MWCNTs | 1.92 | (1%) |
| Ex. 1 | Functionalized graphene | 0.384 | (0.2%) |

*%, based on the weight of the vinyl ester resin solution prepared in Step 1.

### Specific Surface Area

### Test Method: BET

### Results:

The results of BET test for the MWCNT and the functionalized graphene prepared above are listed in Table 2. It can be seen from Table 2 that the functionalized graphene has a specific surface area of S_{BET}=915 m²/g, which is about four times greater than that of MWCNT.

TABLE 2

| | S_{BET}(m²/g) |
|---|---|
| MWCNT | 217 |
| Functionalized graphene | 915 |

### Electrical Properties:

### Test Method:

A four-point probe resistivity meter was used by applying a voltage and an electric current on the surface of a specimen at one end, measuring at the other end the voltage and the electric current passed through the specimen, and using the Ohm's law to obtain the volume resistivity (ρ) of the specimen according to the formula,

$$ρ = \frac{V}{I} * W * CF , \qquad ( formula 1 )$$

wherein V is the voltage passed through the specimen, I is the electric current passed through the specimen, a ratio thereof is the surface resistivity, W is the thickness of the specimen, and CF is the correction factor. The thermally compressed specimens from the examples and the control example were about 100 mm×100 mm with a thickness of 1.2 mm. The correction factor (CF) for the specimens was 4.5. Formula 1 was used to obtain the volume resistivity (ρ) and an inversion of the volume resistivity is the electric conductivity of a specimen.

### Results:

Table 3 shows the electric conductivity measured for the composite conducting plates prepared above, wherein the resin formulas and the content of graphite powder are the same with different amounts of carbon nanotubes (Control Examples 1-4) and with 0.2 wt % of functionalized graphene (Example 1). The measured conductivities for the composite conducting plates prepared in Control Examples 1-3 increase as the amount of the carbon nanotubes used increases; however, the conductivity of the composite conducting plate prepared in Control Example 4 (with 1.0 wt % of MWCNTs) lower than that of the conducting plate prepared in Control Example 3 (with 0.5 wt % of MWCNTs). This might be due to the poor dispersion of MWCNTs in the polymer matrix, which typically appear as clusters in the polymer matrix, when the amount of MWCNTs is increased to 1.0 wt %, which in turn causes the decrease in the number of the conducting paths in the polymer matrix. The conductivity of Example 1 where 0.2 wt % of functionalized graphene is used is the highest. It is believed that the functionalized graphene is better dispersed in the polymer matrix because the residue oxygen-containing functional groups of the functionalized graphene mitigate the aggregation of the functionalized graphene, and thus more conducting paths are formed in the polymer matrix. The results of Table 3 show a relatively less amount of functionalized graphene is required to enhance the electric conductivity of the conducting plate in comparison with MWCNTs, and the value of 286.4 S/cm of Example 1 is 0.186% higher than the target value (>100 S/cm) set by the US DOE.

TABLE 3

| | Electric conductivity (S/cm) |
|---|---|
| Control Ex. 1 | 155.7 |
| Control Ex. 2 | 168.3 |
| Control Ex. 3 | 261.1 |
| Control Ex. 4 | 233.7 |
| Example 1 | 286.4 |

### Mechanical Property: Test for Flexural Strength

### Method of Test ASTM D790

### Results:

Table 4 shows the test results of flexural strength for composite conducting plates prepared above, wherein the resin formulas and the content of graphite powder are the same with different amounts of carbon nanotubes (Control Examples 1-4) and with 0.2 wt % of functionalized graphene (Example 1). The measured flexural strength for the composite conducting plates prepared in Control Examples 1-4 increases as the amount of MWCNTs increases (0 wt % to 1.0 wt %), but the highest thereof still lower that of Example 1 where functionalized graphene is used (0.2 wt %). The MWCNTs used in control Examples have a smaller specific surface area in comparison with graphene, and have atomically smooth nonreactive surfaces without modification, so that MWCNTs are lack of interfacial interaction or bonding with the polymer matrix, and this in turn limits load-transfer efficiency from the polymer matrix to MWCNTs; consequently, the flexural strength of the composite is lower than that of the composite conducting plate in Example 1. By comparison, the functionalized graphene shows good dispersion and good compatibility with the polymer matrix due to polarity interactions and hydrogen bonding among hydroxyl and carbonyl groups in vinyl ester resin and partial oxygenation extended the 2D graphene surface. The distortions caused by oxygen functionalization, as well as the few nanometer thickness, resulted in a wrinkled, wave-like topology with nanoscale roughness. This unique surface texture with nanoscale roughness leads to an enhanced mechanical interlocking with the polymer matrix. Because of possible grafting of vinyl ester chains on graphene, observations show that the graphene sheets embed in the polymer matrix, where they are tightly held. To sum, the polymer matrix load transfers to graphene more effectively than to MWCNT, hence, significantly improving the flexural strength of functionalized graphene/vinyl ester composite conducting plate. In Example 1 where 0.2 wt % of functionalized graphene was used, the flexural strength thereof is greater that that of Control Example 4 where 1.0 wt % of MWCNTs was added, which also exceeds the DOE target value (>25 MPa) by 96.8%.

TABLE 4

| | Flexural strength (MPa) |
|---|---|
| Control Ex. 1 | 28.0 |
| Control Ex. 2 | 33.4 |
| Control Ex. 3 | 46.2 |
| Control Ex. 4 | 47.7 |
| Example 1 | 49.2 |

### Thermal Conductive Property: Thermal Conductivity Coefficient

Thermal conductivity coefficient was measured by using a hot disk thermal analyzer (TPS2500, Sweden) in accordance with the transient plane source (TPS) technique proposed by Zhu et al. (D. Zhu, X. Li, N. Wang, X. Wang, J. Gao, H. Li, Curr. Appl. Phys., 2009, 9, 131.), wherein sensors were mounted between two conducting plates of a dimension of 50×50×4 mm. The thermal conductivity coefficient of the conducting plate was measured by data fitting according to the method disclosed by Gustaysson et al. (M. Gustaysson, E. Karawacki, S. E. Gustafsson, Rev. Sci. Instrum., 1994, 65, 3856.)

### Results:

Table 5 shows the test results of thermal conductivity coefficient for composite conducting plates prepared above, wherein the resin formulas and the content of graphite powder are the same with different amounts of carbon nanotubes (Control Examples 1-4) and with 0.2 wt % of functionalized graphene (Example 1). The measured thermal conductivity coefficient for the composite conducting plates prepared in Control Examples 1-3 increase as the amount of the carbon nanotubes used increases; however, the thermal conductivity coefficient of the composite conducting plate prepared in Control Example 4 (with 1.0 wt % of MWCNTs) lower than that of the conducting plate prepared in Control Example 3 (with 0.5 wt % of MWCNTs). This might be due to a reduction in the real aspect ratio of MWCNTs as MWCNTs aggregate in the polymer matrix, when the amount of MWCNTs is increased to 1.0 wt %, which in turn causes the thermal conductivity coefficient a slightly lower. The thermal conductivity coefficient of Example 1 where 0.2 wt % of functionalized graphene is used is the highest. It is believed that the functionalized graphene has a greater specific surface area and greater aspect ratio (about 4700-2900 estimated from FIG. 1, where the length and width are about 6.5 μm×4 μm, and the thickness is about 1.4 nm), so that the functionalized graphene with a greater aspect ratio is more effectively to be well dispersed in the polymer matrix, and thus enhances the thermal conductivity of the conducting plate more efficiently. The results of Table 5 show a relatively less amount of functionalized graphene (0.2 wt %) is able to enhance the thermal conductivity of the conducting plate prepared in Example 1 comparably to Control Example 3 (0.5 wt % of MWCNTs), and 27.2 W/m K of Example 1 exceeds the target value (>20 W/m K) set by the US DOE by 36%.

TABLE 5

| | Thermal conductivity coefficient |
|---|---|
| | (W/m K) |
| Control Ex. 1 | 18.4 |
| Control Ex. 2 | 20.0 |
| Control Ex. 3 | 27.3 |
| Control Ex. 4 | 25.0 |
| Example 1 | 27.2 |

The resin formulas and the content of graphite powder (70 wt %) are the same with different amounts of carbon nanotubes in Control Examples 1-4 and with 0.2 wt % of functionalized graphene in Example 1. The graphite powder used in Control Examples 1-4 and Example 1 consists of not more than 10% of particles larger than 40 mesh (420 μm in diameter), about 40% of particles between 40 mesh and 60 mesh (420−250 μm in diameter), and about 50% of particles between 60 mesh and 80 mesh (250−177 μm in diameter). Test results for the conducting plates prepared in Control Examples 1-4 and Example 1 indicate that utilizing functionalized graphene as reinforcement for composite conducting plate significantly out-performs MWCNT as reinforcement for composite conducting plate with a less loading. In Example 1, the functionalized graphene is more compatible with the polymer matrix because the residue oxygen-containing functional groups of the functionalized graphene mitigate the aggregation of the functionalized graphene in the polymer matrix. Further, special two-dimension topography of the functionalized graphene, which includes high surface area, high aspect ratio, wrinkled structure, provides good interfacial adhesion with the vinyl ester matrix.

1. A process for preparing a graphite-vinyl ester resin composite conducting plate reinforced by a functionalized graphene comprising the following steps:
a) compounding vinyl ester resin and graphite powder to form bulk molding compound (BMC) material, the graphite powder content ranging from 70 wt % to 95 wt % based on the total weight of the graphite powder and vinyl ester resin, wherein 0.01-15 wt % a functionalized graphene, based on the weight of the vinyl ester resin, is added during the compounding; and
b) molding the BMC material from step a) to form a conducting plate having a desired shaped at 80-250° C. and 500-4000 psi.

2. The process of claim 1, wherein said functionalized graphene is a single-layered or a multiple-layered graphene, and has a length and a width of 100 nm-500 μm; and a thickness of 0.34 nm-10 nm.

3. The process of claim 2, wherein said functionalized graphene is a 1- to 9-layered graphene, and has a length and a width of 1.0 μm-10.0 μm; and a thickness of 1.0 nm-5.0 nm.

4. The process of claim 1, wherein said functionalized graphene has a specific surface area of 100-2630 m²/g.

5. The process of claim 1, wherein said functionalized graphene has an oxygen-containing functional group of COOH, C—OH, C═O or C—O—C, the content of which is less than a weigh loss of 10 wt % measured by thermogravimetric analysis (TGA) heating from 100° C. to 800° C. at a heating rate of 2° C./min.

6. The process of claim 1, wherein said functionalized graphene is added with an amount of 0.1-2.0 wt % based on the weight of the vinyl ester resin.

7. The process of claim 1, wherein said functionalized graphene is prepared by reducing a graphite oxide having an oxygen-containing functional group of COOH, C—OH, C═O or C—O—C, the content of which is greater than a weight loss of 20 wt %, more preferably 30 wt %, measured by thermogravimetric analysis (TGA) heating from 100° C. to 800° C. at a heating rate of 2° C./min.

8. The process of claim 7, wherein the content of the oxygen-containing functional group of said graphite oxide is greater than a weight loss of 30 wt % measured by thermogravimetric analysis (TGA) heating from 100° C. to 800° C. at a heating rate of 2° C./min.

9. The process of claim 7, wherein said reduction is a chemical reduction, thermal reduction, hydrothermal reduction or a combination thereof.

10. The process of claim 9, wherein said reduction is the thermal reduction carried out at a temperature of 150-1200° C. with a heating rate of 10-2000° C./min in an inert atmosphere for a period of 5-300 seconds.

11. The process of claim 7, wherein said graphite oxide having an oxygen-containing functional group is formed by oxidizing graphite powder with a strong acid and a strong oxidizing agent for a period of two hours to 10 days.

12. The process of claim 11, wherein the graphite powder being oxidized is natural graphite powder, expanded graphite, graphite carbon, soft graphite, or a mixture thereof.

13. The process of claim 11, wherein the strong acid is an inorganic acid.

14. The process of claim 11, wherein the oxidizing agent is KClO₃, KClO₄, KMnO₄, NaMnO₄, K₂S₂O₈, P₂O₅, NaNO₃ or a mixture thereof.

15. The process of claim 9, wherein said reduction is a chemical reduction by using a reducing agent selected from be hydrazine (N₂H₂), hydroquinone, sodium borohydride (NaBH₄), sodium citrate, hydroxide, ascorbic acid and a mixture thereof.

16. The process of claim 9, wherein said reduction is hydrothermal reduction by using water, alcohol, organic solvent or a mixture thereof.

17. The process of claim 1, wherein the conducting plate prepared has an electric conductivity not less than 250 S cm⁻¹.

18. The process of claim 1, wherein the conducting plate prepared has a flexural strength not less than 40 MPa.

19. The process of claim 1, wherein the conducting plate prepared has a thermal conductivity not less than 20 W/m K.

20. A process for preparing a bipolar plate for fuel cell, which comprises steps a) and b) as recited in claim 1.

21. A process for preparing a counter electrode for dye-sensitized solar cell, which comprises steps a) and b) as recited in claim 1.

22. A process for preparing an electrode of vanadium redox battery, which comprises steps a) and b) as recited in claim 1.
